(19) United States
(12) Patent Application Publication
(10) Pub. No.: US 2010/0083441 A1
(43) Pub. Date: Apr. 8, 2010

(54) NURSING BED

(76) Inventor: Takayuki Ishida, Ibaraki (JP)

Correspondence Address: The Law Office of Michael E. Kondoudis, 888 16th Street, NW, Suite 800, Washington, DC, 20006, US

(21) Appl. No.: 12/522,487

(22) PCT Filed: Jan. 11, 2008
(86) PCT No.: PCT/JP2008/050257

§ 371 Date: Jul. 8, 2009

(30) Foreign Application Priority Data
Jan. 31, 2007 (JP) 2007-021586

(51) Int. Cl. A61G 7/02

(52) U.S. Cl. 5/604

(57) ABSTRACT

The present invention is a nursing bed (1) having a mat body (3) provided with an upper body receiving section (8) constructed from a backrest section (11) and a waist receiving section (12) that are pivotally connected together. A hip receiving section (7) is split into the left and right, and the left and right hip receiving sections (7a, 7b) are arranged so as to be slidable in the directions of approaching and separating from each other. To use a toilet bowl (20), the waist receiving section (12) is rotated upward about a pivotally connected section (14) at which the waist receiving section (12) and the backrest section (11) are connected and then the left and right hip receiving sections (7a, 7b) are slid in the direction of their separation to thereby form an opening. After that, the toilet bowl (10) is raised to the opening, the waist receiving section (12) is rotated downward about the pivotally connected section (14), and then the backrest section (11) is rotated in the direction in which it rises.

### CROSS-REFERENCE TO RELATED APPLICATION

This application is a national phase for the United States of PCT Application No. PCT/JP2008/050257, filed Jan. 11, 2008, entitled NURSING BED, which is related to and claims priority to Japanese Patent Application No.2007-021586, filed Jan. 31, 2007, entitled NURSING BED, the entirety of which is incorporated herein by reference.

### FIELD OF THE INVENTION

The present invention relates to a nursing bed for a person to be cared, more specifically, it relates to a nursing bed comprising a toilet bowl.

### BACKGROUND OF THE INVENTION

Conventionally, when a person to be cared such as the physically challenged or an aged person who are bedridden evacuates the bowels, it is laborsome for a caregiver such as a nurse to care them. Therefore in recent years the various nursing beds are suggested for the purpose of making the person to be cared evacuated by himself or herself in order to lighten labor of the caregiver.

For example, there is a known nursing bed, as one of conventional nursing beds, wherein the opening is formed at the position corresponding to the hip part of the person to be cared when the person to be cared laying on the bed operates a switch, and the toilet bowl is moved to be set at the opening during evacuating the bowels, and then the opening is closed by a mat after evacuating the bowels (see JP2001-212186A).

However, at the above-mentioned prior nursing bed, there is a problem that the person to be cared can not apply enough power to evacuate the bowels fully because he or she evacuate the bowels while he or she is laying.

Furthermore, there is a problem to make the person to be cared felt uneasy, or to force the person to be cared to take a constrained position because there is no mat at the position corresponding to the hip part of the person to be cared until the toilet bowl is set at the opening when evacuating the bowls and thus the person to be cared can not be supported by the bed.

In order to overcome the above problems, the object of the present invention is to provide a nursing bed that the person to be cared can evacuate the bowels easily, and he or she does not feel uneasy and take the constrained position when evacuating the bowels.

### SUMMARY OF THE INVENTION

In order to achieve the above objects, the present invention is a nursing bed comprising a mat body split into at least a hip receiving section and an upper body receiving section for receiving an upper body part than the hip receiving section and a lower body receiving section for receiving an lower body part than the hip receiving section, and a toilet bowl arranged so as to be able to elevate under the hip receiving section, wherein the upper body receiving section of the mat body is constructed from a backrest section and a waist receiving section that are pivotally connected together, the hip receiving section is split into the left and right, the left and right hip receiving sections are arranged so as to be slidable in the directions of approaching and separating from each other, at the time of using a toilet bowl the waist receiving section is rotated upward about a pivotally connected section at which the waist receiving section and the backrest section are connected, then the left and right hip receiving sections are slid in the direction of their separation to thereby form an opening, after the toilet bowl is raised to the opening, the waist receiving section is rotated downward about the pivotally connected section, and then the backrest section is rotated in the direction in which it rises.

It is preferred that the lower body receiving section of the mat body is constructed from a thigh receiving section and a crus receiving section that are pivotally connected together, and at the time of using a toilet bowl after a pivotally connected section at which the thigh receiving section and the crus receiving section are connected is raised, the waist receiving section is rotated upward about the pivotally connected section at which the waist receiving section and the backrest section are connected.

It is preferred that a single-use material for disposing urine and stools are arranged in the toilet bowl which is arranged so as to be slidable in the left and right.

It is preferred that the left and right hip receiving sections are respectively constructed from an inside part and an outside part that are pivotally connected together, when the left and right hip receiving sections slide in the directions of approaching and separating from each other, the only each inside part slides in outside respectively, and then pivotally connected section at which the inside part and the outside part are connected is raised so as to take the form of mountain.

It is preferred that the toilet bowl comprises a urine receiving part which is arranged so as to be movable up and down in front of a person to be cared who sits on a toilet seat, the urine receiving part moves above the toilet seat in when using it to lead urine of the person to be cared to inside of the toilet bowl, and it is housed in the toilet bowl when disusing.

It is preferred that the toilet bowl comprises a container for housing urine and stools, and the container for housing urine and stools can be pulled out from an opening formed at the side face of the toilet bowl to the outside.

According to the present invention, the person to be cared does not feel uneasy and take the constrained position when evacuating the bowels because the waist receiving section is rotated upward about a pivotally connected section at which the waist receiving section and the backrest section are connected and then supports the waist receiving of the person to be cared when the toilet bowl is set at the opening.

The waist receiving section can lift up the waist of the person to be cared at the minimum power because the lower body part than the waist part of the person to be cared is lifted up by the thigh receiving section and the crus receiving section when the waist receiving section lifts up the waist of the person to be cared.

Furthermore, the person to be cared can take position to apply power easily when evacuating the bowels and thus he or she can evacuate the bowels easily and comfortably because the upper body part than the hip part of the person to be cared is raised when evacuating the bowels.

In addition, it is possible to keep up good sanitary condition because the single-use material for disposing urine and stools prevents urine and stools evacuated from the person P to be cared from spattering and houses them fully, the caregiver can dispose the urine and stools easily and thus it is possible to lighten labor of the caregiver.

### BRIEF DESCRIPTION OF THE DRAWINGS

FIG. 1 is a perspective view of the nursing bed according to an embodiment of the present invention;

FIG. 2 is a plan view of the nursing bed according to an embodiment of the present invention;

FIG. 3 is a plan view of the nursing bed under evaluating the bowels according to an embodiment of the present invention;

FIG. 4 is a side view of the toilet unit of the nursing bed according to an embodiment of the present invention;

FIG. 5 is a sectional view of the toilet unit of the nursing bed according to an embodiment of the present invention;

FIG. 6 is a side view of action of the nursing bed according to an embodiment of the present invention;

FIG. 7 is a side view of action of the nursing bed according to an embodiment of the present invention;

FIG. 8 is a side view of action of the nursing bed according to an embodiment of the present invention;

FIG. 9 is a side view of action of the nursing bed according to an embodiment of the present invention;

FIG. 10 is a perspective view of another example of the nursing bed according to an embodiment of the present invention;

FIG. 11 is a sectional view of another example of the toilet unit of the nursing bed according to an embodiment of the present invention.

### DESCRIPTION OF THE PREFERRED EMBODIMENT

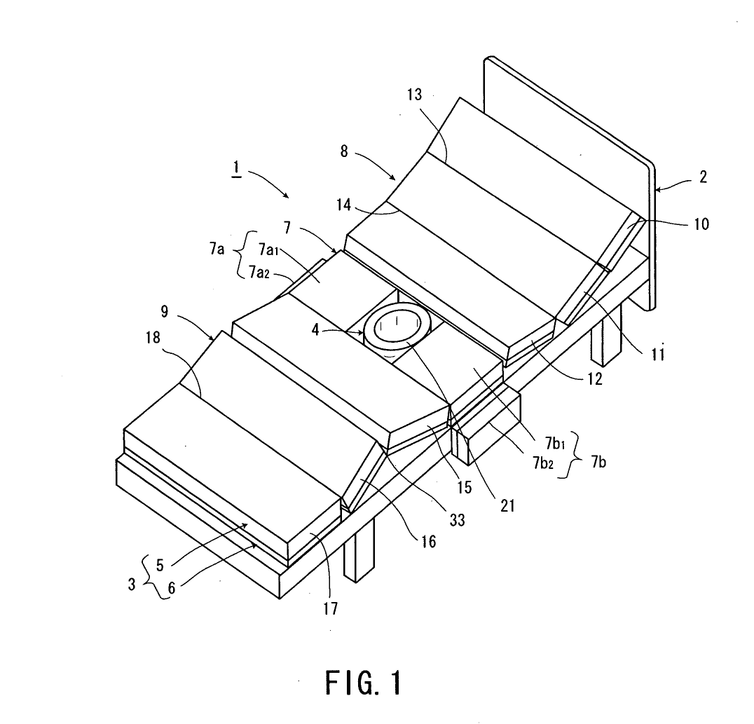

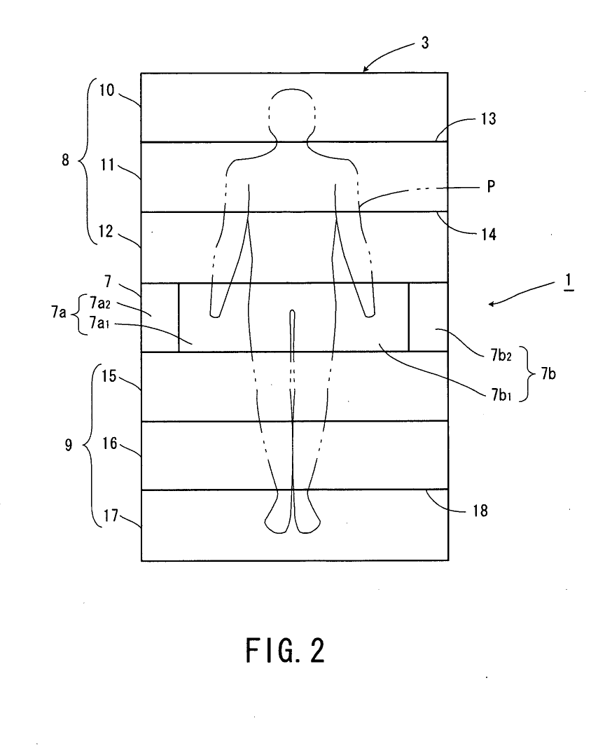

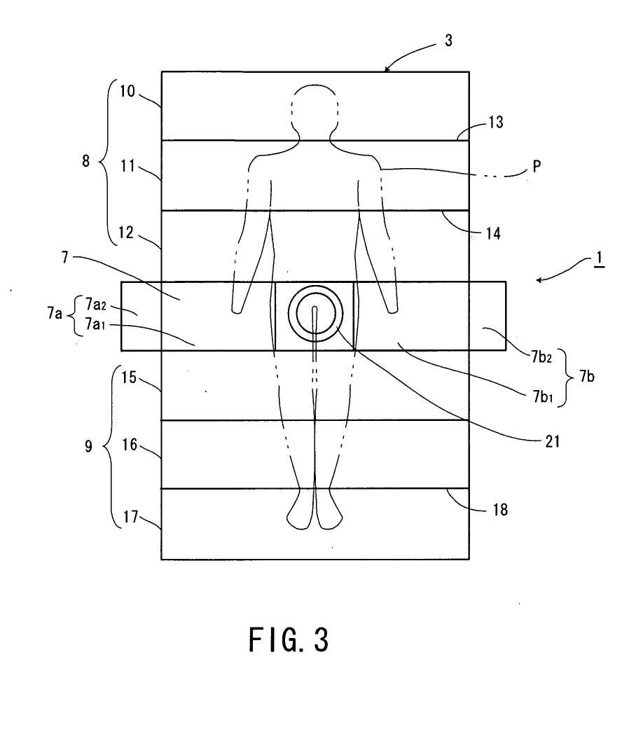

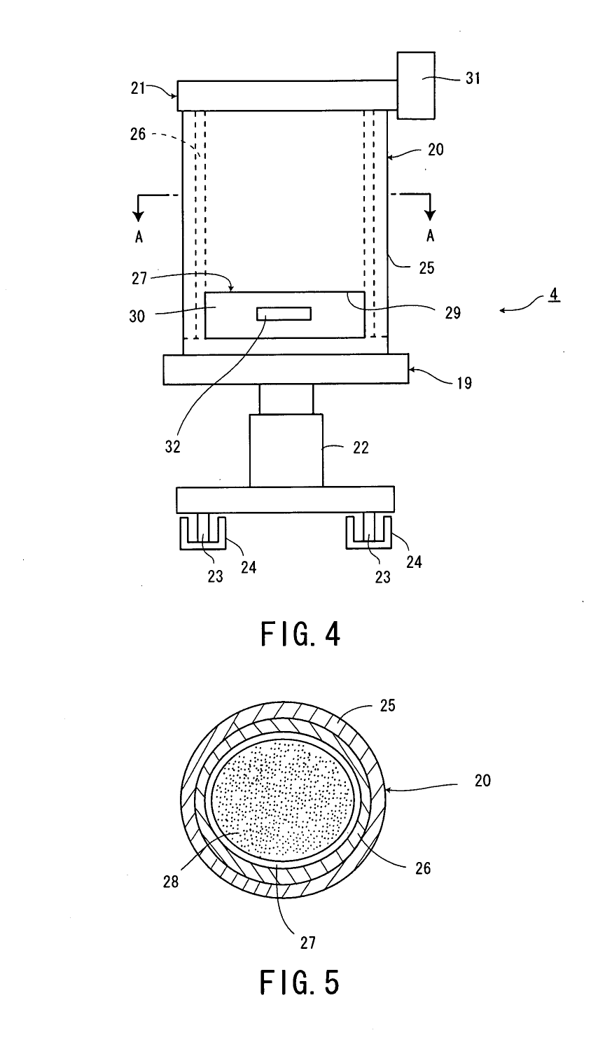

We will now describe an embodiment of the present invention with reference to the accompanying drawings. The FIG. 1 is a perspective view of the nursing bed according to an embodiment of the present invention, FIG. 2 is a plan view of the nursing bed according to an embodiment of the present invention, FIG. 3 is a plan view of the nursing bed under evaluating the bowels according to an embodiment of the present invention, FIG. 4 is a side view of the toilet unit of the nursing bed according to an embodiment of the present invention, FIG. 5 is a sectional view of the toilet unit of the nursing bed according to an embodiment of the present invention.

A nursing bed 1 according to an embodiment of the present invention comprises a bed frame body 2, a mat body 3 supported by the bed frame body 2, and a toilet unit 4 arranged under the mat body 3. Furthermore, the mat body 3 is constructed from a flexible mat member 5 and a support member 6 arranged at the backside of the mat member 5.

The mat body 5 is split into a hip receiving section 7 for supporting the hip part of a person P to be cared who lies on the nursing bed 1, an upper body receiving section 8 for receiving an upper body part than the hip receiving section 7, and a lower body receiving section 9 for receiving an lower body part than the hip receiving section 7. Furthermore, the hip receiving section 7 is split into the left and right, the left and right hip receiving sections 7a, 7b are arranged so as to be slidable in the directions of approaching and separating from each other, and the left and right hip receiving sections 7a, 7b are respectively constructed from an inside part 7a₁, 7b₁ and an outside part 7a₂, 7b₂ that are pivotally connected together.

The upper body receiving section 8 is constructed from a head receiving section 10 for supporting the head of the person to be cared who lies on the nursing bed 1, a back receiving section 11 for supporting the back of the person to be cared, and a waist receiving section 12 for supporting the waist of the person to be cared. The head receiving section 10 and the back receiving section 11, and the back receiving section 11 and the waist receiving section 12 are pivotally connected respectively about a first pivotally connected section 13 and a second pivotally connected section 14 formed at the top face side by means of a driving power and a transmission mechanism which are not shown on figures. Various driving power such as electric one like a motor and an actuator etc. or pneumatic driving one and the like can be used as the driving power in this case, and also a linkage or a gear, pulley and the like can be used as the transmission mechanism. However, we do not explain the details herein since these can be realized by prior known arts.

On the other hand, the lower body receiving section 9 is constructed from a thigh receiving section 15 for supporting the thigh of the person to be cared who lies on the nursing bed 1, and a crus receiving section 16 for supporting the crus of the person to be cared, and a calcaneus receiving section 17 for supporting the calcaneus of the person to be cared. The thigh receiving section 15 and the crus receiving section 16 are pivotally connected respectively about a third pivotally connected section 33 formed at the under face side by means of the driving power and the transmission mechanism. The crus receiving section 16 and the calcaneus receiving section 17 are pivotally connected respectively about a fourth pivotally connected section 18 formed at the top face side by means of the driving power and the transmission mechanism.

The toilet unit 4 is constructed from a base 19, a toilet bowl 20 fixed on the base 19, and a toilet seat 21 arranged on the toilet bowl 20, as shown on the FIG. 4 and FIG. 5.

The base 19 is arranged so as to be able to elevate by an elevating mechanism such as a hydraulic mechanism 22 and the like, and wheels 23 arranged at the lower end moves in the left and right in an extendable rail 24 so that it is slidable in the left and right.

The toilet bowl 20 is constructed from a bowl body 25 in the shape of a bucket made from polyethylene, a tubular member 26 made of cardboard inserted along the inside face of peripheral wall of the bowl body 25, and a container 27 for housing urine and stools in the shape of a circular pan made from polyethylene put on the bottom part of the toilet body 25. A single-use absorbent material 28 for disposing urine and stools is filled in the container 27 for housing urine and stools, and the container 27 has capacity that can house one or two times of urine and stools.

In addition, an opening 29 extending from side to side is formed at the lower end of the bowl body 25. The opening 29 is formed so as to be able to be closed by a side face 30 having a handle 32 of the container 27, and the container 27 is arranged so as to be able to draw outside through the opening 29.

The toilet seat 21 is one with heating and washing function, is arranged so as to rotate upward about one end and maintain at the rising position. Furthermore, the toilet seat 21 comprises a cartridge type of washing water tank 31, the washing water tank 31 has capacity that can house one or two times of washing water.

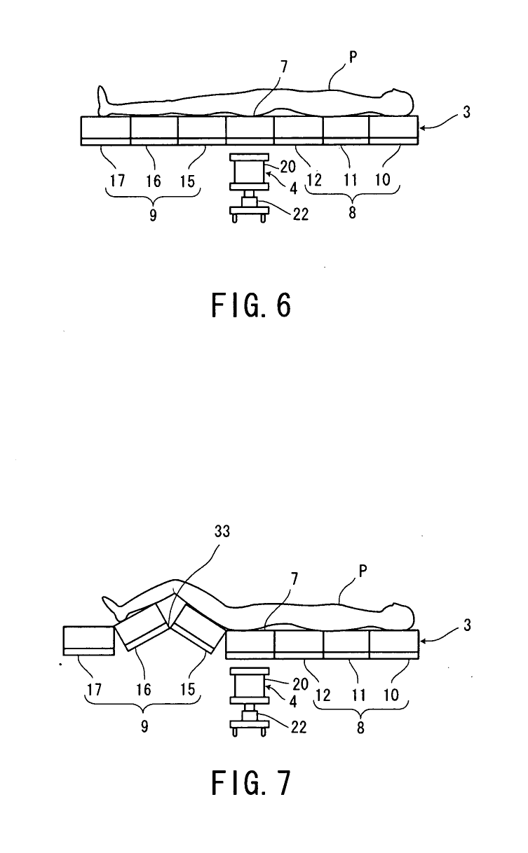

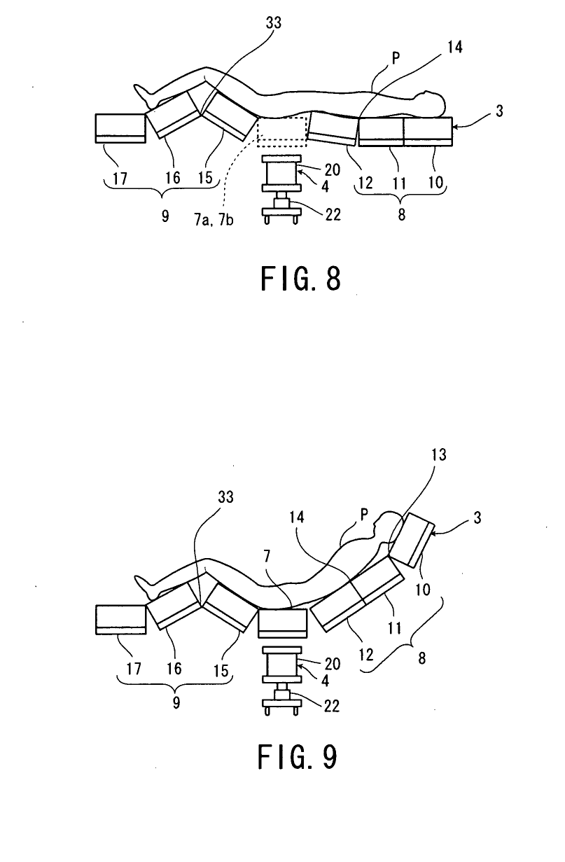

Next, we will describe action of the above mentioned nursing bed 1 with reference to the FIG. 6 to FIG. 9 mainly. FIG. 6 is a side view of action of the nursing bed according to an embodiment of the present invention, FIG. 7 is a side view of action of the nursing bed according to an embodiment of the present invention, FIG. 8 is a side view of action of the nursing bed according to an embodiment of the present invention, FIG. 9 is a side view of action of the nursing bed according to an embodiment of the present invention.

Under the condition that the person P to be cared is laying on his back on the nursing bed 1 as shown on the FIG. 6, when he pushes the start button of a remote control (not shown), the following action is carried out automatically until it makes the person P to be cared taken a position for evacuating the bowls.

Concretely, as sown on the FIG. 7, the third pivotally connected section 33 of the thigh receiving section 15 and the crus receiving section 16 of the mat body 3 is raised, the thigh receiving section 15 is rotated downward (in the direction of clockwise on the FIG. 7) about the third pivotally connected section 33, and the crus receiving section 16 is rotated downward (in the direction of counterclockwise on the FIG. 7) about the third pivotally connected section 33. Thus, the lower body part than the hip part of the person P to be cared is lifted up, and the lower body part of the person P to be cared becomes condition drawing up the knees.

Next, as shown on the FIG. 8, the waist receiving section 12 is rotated upward (in the direction of clockwise on the FIG. 8) about the second pivotally connected section 14, and the waist part of the person P to be cared is lifted up gently. Thus, the hip part of the person to be cared becomes floating condition above the hip receiving section 7. In this case, the waist receiving section 12 can lift up the waist part of the person P to be cared at minimum power since the lower body part is lifted up by the thigh receiving section 15 and the crus receiving section 16 above the hip part of the person P to be cared.

After that, the left and right hip receiving sections 7a, 7b slide in the directions of approaching and separating from each other, and the outside part 7a₂, 7b₂ is rotated downward respectively about the lower face side to the inside part 7a₁, 7b₁. Thus, an opening is formed under the hip part of the person P to be cared. At this time, the person P to be cared does not feel uneasy and take the constrained position to maintain this position because the waist part of the person P to be cared is supported by the waist receiving section 12.

Next, as shown the FIG. 9, the toilet bowl 20 is lifted up by the hydraulic mechanism 22, and is moved to this opening to be set. After that, the waist receiving section 12 is rotated downward (in the direction of counterclockwise on the FIG. 9) about the second pivotally connected section 14, and the back receiving section 11 and the head receiving section 10 are rotated in the direction in which it rises (in the direction of counterclockwise on the FIG. 9) about the second pivotally connected section 14 and the first pivotally connected section 13 respectively. Thus, the person P to be cared can take position to apply power easily when evacuating the bowels because the hip part of the person P to be cared is put on the toilet seat 21 and the upper body part than the hip part of the person P to be cared is raised. Therefore, the person P to be cared can evacuate the bowels easily and comfortably. In addition, it is possible to keep up good sanitary condition, because the tubular member 26 or the single-use material 28 for disposing urine and stools prevents urine and stools evacuated from the person P to be cared from spattering and houses them fully.

After the person P to be cared finishes to evacuate the bowls taking the position for evacuating the bowls as described the above, when he or she push the finish button of the remote control (not shown), the opposite action of the above mentioned action is carried out automatically, and the nursing bed 1 is returned to the normal condition which the person P to be cared can lie on his back as shown on the FIG. 6. And besides, after evacuating the bowls, the upper end of the toilet bowl 20 may hit on the lower face of the hit receiving section 7 of the mat body 3 so as to prevent odor from discharging from the upper opening of the toilet bowl 20.

In order that the caregiver disposes the evacuation after the person P to be cared evacuates the bowls, he or she makes the toilet unit 4 slid along the rail 24 extending in either side of left or right to draw out to the outside of the mat body 3. Next, under the condition to draw out the toilet unit 4 to the outside of the mat body 4 as described the above, the caregiver draws the container 27 for housing urine and stools from the toilet bowl 20 by pulling the handle 31, and discard the single-use material 28 for disposing urine and stools used to change it to new one 28. Furthermore, after the caregiver draws the tubular member 22 upward to discard it and change it to a new tubular member under the condition to make the toilet seat 21 rotated upwards about one end to keep the rising position, he or she makes the toilet seat 21 rotated downward to return it to the original position. Then, after disposing the urine and stools and changing the single-use material 28 and the tubular member 26 to new ones, the caregiver sets the toilet unit 4 at the predetermined position under the mat body 3 along the rail 24.

Thus, it is possible to lighten labor of the caregiver since the caregiver can dispose the urine and stools easily by changing the single-use material 28 and the tubular member 26 to new ones.

In addition, although at the aforementioned preferred embodiment of the present invention the urine and stools are disposed by the single-use material 28 and the tubular member 26, this is merely one example and it is possible to carry out various changes such that the present invention comprises a portable toilet material attaching a paper nappy on the inside of a vinyl bag which is expanded in the toilet bowl 20 and whose upper end is hooked on the upper end of the toilet bowl 20 or the toilet seat 21 to set, and change the portable toilet material to a new one after it houses the urine and stools in. In this case, it is possible to further lighten labor of the caregiver since the opening 29 of the toilet bowl 20 is not required to draw the container 27 for housing urine and stools from it and also the caregiver can dispose the urine and stools more easily by changing the single-use material 28.

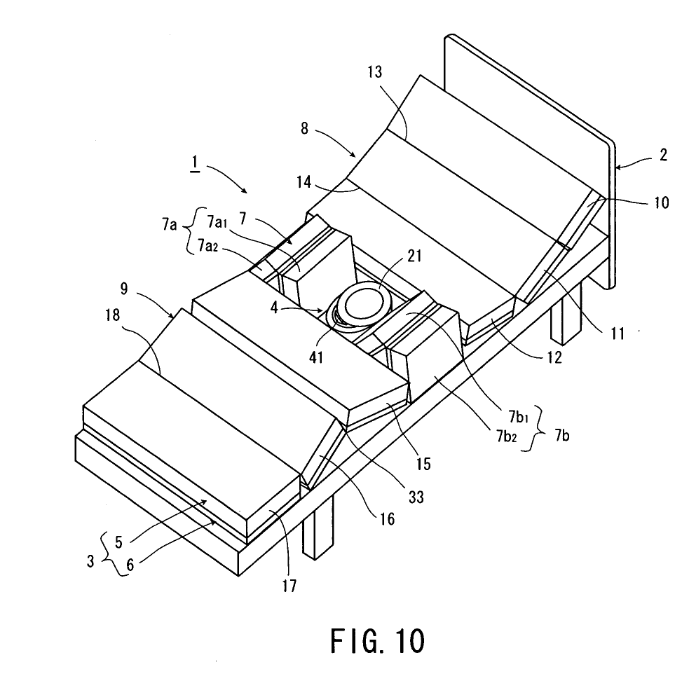

And also as shown on the FIG. 10, when the left and right hip receiving sections 7a, 7b slide in the directions of approaching and separating from each other, the only each inside part 7a₁, 7b₁ may slide in outside respectively, and then pivotally connected section at which the inside part 7a₁, 7b₁ and the outside part 7a₂, 7b₂ are connected may be raised so as to take the form of mountain. Thus, it is possible to make the left and right hip receiving sections 7a, 7b slid smoothly even though there are any obstacles by the left and right side of the nursing bed since the outside parts 7a₂, 7b₂ do not project into the left and right side of the nursing bed 1 when the left and right hip receiving sections 7a, 7b slide into the left and right outside.

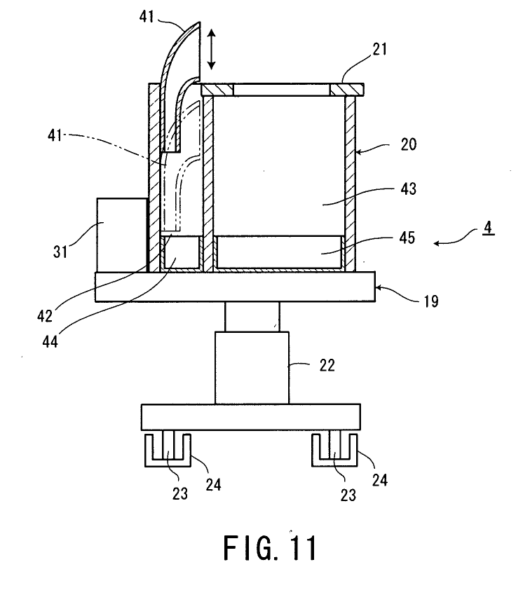

Furthermore, as shown on the FIG. 10 and FIG. 11, the toilet bowl 20 may comprise a urine receiving section 41 which is arranged so as to be movable up and down in front of a person to be cared who sits on a toilet seat 21, the urine receiving section 41 may move above the toilet seat 21 in when using it to lead urine of the person to be cared to inside of the toilet bowl 20 as shown using the real line on the FIG. 11, and it may be housed in the toilet bowl 20 when disusing as shown using the two point chain line on the FIG. 11.

In addition, the inside of the toilet bowl 20 is split into a urinal part 42 and a stool part 43, and a container 44 for housing urine and a container 45 for housing stools in the shape of a pan which are processed by Teflon (Registered Trademark) for example are arranged at each bottom of the urinal part 42 and the stool part 43. The container 44 for housing urine and the container 45 for housing stools can be pulled out from an opening (not shown) formed at the side face of the toilet bowl 20 to the outside. A single-use absorbent material for disposing urine and stools or a vinyl bag may be set in each inside of the container 44 for housing urine and the container 45 for housing stools.

And besides, the urine receiving section 41 may be arranged so as to elevate automatically by operating the switch or manually in this case. In addition, the toilet bowl 20 may have function for washing the hip and a washing water tank. Furthermore, the toilet bowl 20 may have a lid for preventing odor which opens and closes automatically.

What is claimed is:

1. A nursing bed comprising a mat body split into at least a hip receiving section and an upper body receiving section for receiving an upper body part than the hip receiving section and a lower body receiving section for receiving an lower body part than the hip receiving section, and a toilet bowl arranged so as to be able to elevate under the hip receiving section,
wherein the upper body receiving section of the mat body is constructed from a backrest section and a waist receiving section that are pivotally connected together, the hip receiving section is split into the left and right, the left and right hip receiving sections are arranged so as to be slidable in the directions of approaching and separating from each other, at the time of using a toilet bowl the waist receiving section is rotated upward about a pivotally connected section at which the waist receiving section and the backrest section are connected, then the left and right hip receiving sections are slid in the direction of their separation to thereby form an opening, after the toilet bowl is raised to the opening, the waist receiving section is rotated downward about the pivotally connected section, and then the backrest section is rotated in the direction in which it rises.

2. The nursing bed according to claim 1, wherein the lower body receiving section of the mat body is constructed from a thigh receiving section and a crus receiving section that are pivotally connected together, and at the time of using a toilet bowl after a pivotally connected section at which the thigh receiving section and the crus receiving section are connected is raised, the waist receiving section is rotated upward about the pivotally connected section at which the waist receiving section and the backrest section are connected.

3. The nursing bed according to claim 2, wherein a single-use material for disposing urine and stools are arranged in the toilet bowl which is arranged so as to be slidable in the left and right.

4. The nursing bed according to claim 1, wherein the left and right hip receiving sections are respectively constructed from an inside part and an outside part that are pivotally connected together, when the left and right hip receiving sections slide in the directions of approaching and separating from each other, the only each inside part slides in outside respectively, and then pivotally connected section at which the inside part and the outside part are connected is raised so as to take the form of mountain.

5. The nursing bed according to claim 1, wherein the toilet bowl comprises a urine receiving section which is arranged so as to be movable up and down in front of a person to be cared who sits on a toilet seat, the urine receiving section moves above the toilet seat in when using it to lead urine of the person to be cared to inside of the toilet bowl, and it is housed in the toilet bowl when disusing.

6. The nursing bed according to claim 1, wherein the toilet bowl comprises a container for housing urine and stools, and the container for housing urine and stools can be pulled out from an opening formed at the side face of the toilet bowl to the outside.
